(19) United States
(12) Patent Application Publication
(10) Pub. No.: US 2026/0301386 A1
(43) Pub. Date: Oct. 1, 2026

(54) VIDEO ANALYSIS METHOD, APPARATUS, COMPUTER DEVICE, STORAGE MEDIUM, AND PROGRAM PRODUCT

(71) Applicant: Beijing Youzhuju Network Technology Co., Ltd., Beijing (CN)

(72) Inventors: Haifeng XU, Beijing (CN); Yiru WANG, Beijing (CN); Tao LIN, Beijing (CN); Senna JIA, Beijing (CN); Jiaoyang LI, Beijing (CN)

(21) Appl. No.: 19/464,323

(22) Filed: Jan. 29, 2026

(30) Foreign Application Priority Data
Mar. 25, 2025 (CN) 202510359198.0

(51) Int. Cl. G06V 10/774; G06V 10/62; G06V 20/40

(52) U.S. Cl. CPC G06V 10/7747; G06V 10/62; G06V 20/47

(57) ABSTRACT

A video analysis method and apparatus, a computer device, a storage medium and a program product, which relate to the technical field of multimedia data processing. The method includes: acquiring at least one target video to be analyzed; for any target video, constructing analysis prompt information for the target video in a plurality of feature dimensions based on a preset guide segment; and analyzing the target video by using the analysis prompt information corresponding to each feature dimension to obtain a target analysis result of the target video in each feature dimension, and displaying the target analysis result on a video analysis page.

### CROSS REFERENCE TO RELATED APPLICATIONS

This application is based on and claims priority of CN application with application No. 202510359198.0 filed on Mar. 25, 2025, the entire disclosure of which is incorporated herein by reference.

### TECHNICAL FIELD

The present disclosure relates to the technical field of multimedia data processing, and in particular, to a video analysis method, an apparatus, a computer device, a storage medium, and a program product.

### BACKGROUND

As an important genre for content release, such as an important genre in a content e-commerce ecosystem, high-quality short videos may attract more users to click or browse, so as to increase data traffic of the short videos.

### SUMMARY

In a first aspect, the present disclosure provides a video analysis method, including: acquiring at least one target video to be analyzed; for any target video, constructing analysis prompt information for the target video in a plurality of feature dimensions based on a preset guide segment; and analyzing the target video by using the analysis prompt information corresponding to each feature dimension to obtain a target analysis result of the target video in each feature dimension, and displaying the target analysis result on a video analysis page.

In a second aspect, the present disclosure provides a video analysis apparatus, including: an acquisition module, configured to acquire at least one target video to be analyzed; a construction module, configured to construct, for any target video, analysis prompt information for the target video in a plurality of feature dimensions based on a preset guide segment; and an analysis display module, configured to analyze the target video by using the analysis prompt information corresponding to each feature dimension to obtain a target analysis result of the target video in each feature dimension, and display the target analysis result on a video analysis page.

In a third aspect, the present disclosure provides a computer device, including: a memory and a processor, where the memory and the processor are communicatively connected to each other, the memory stores computer instructions, and the processor executes the computer instructions to perform the video analysis method according to the first aspect or any corresponding implementation thereof.

In a fourth aspect, the present disclosure provides a computer-readable storage medium storing computer instructions, where the computer instructions are used to cause a computer to perform the video analysis method according to the first aspect or any corresponding implementation thereof.

In a fifth aspect, the present disclosure provides a computer program product including computer instructions, where the computer instructions are used to cause a computer to perform the video analysis method according to the first aspect or any corresponding implementation thereof.

According to the video analysis method, the apparatus, the device, the medium, and the product provided by the present disclosure, the analysis prompt information for the target video in each feature dimension is constructed by using the preset guide segment, so that the target video may be analyzed in a corresponding feature dimension according to each piece of analysis prompt information, to obtain the target analysis result of the target video in each feature dimension.

### BRIEF DESCRIPTION OF THE DRAWINGS

In order to more clearly illustrate the technical solutions in the specific implementations of the present disclosure or in the related art, the following briefly introduces the drawings that need to be used in the description of the specific implementations or the related art. Obviously, the drawings in the following description are some implementations of the present disclosure, and for those of ordinary skill in the art, other drawings may also be obtained from these drawings without any creative effort.

FIG. 1 is a schematic diagram of an application scenario according to an embodiment of the present disclosure;

FIG. 2 is a schematic flowchart of a video analysis method according to an embodiment of the present disclosure;

FIG. 3 is a schematic flowchart of another video analysis method according to an embodiment of the present disclosure;

FIG. 4 is a schematic flowchart of yet another video analysis method according to an embodiment of the present disclosure;

FIG. 5 is a schematic diagram of displaying a video analysis result according to an embodiment of the present disclosure;

FIG. 6 is a schematic diagram of displaying analysis details according to an embodiment of the present disclosure;

FIG. 7 is a schematic flowchart showing details of video analysis according to an embodiment of the present disclosure;

FIG. 8 is a schematic diagram of multi-dimensional video analysis according to an embodiment of the present disclosure;

FIG. 9 is a block diagram of a structure of a video analysis apparatus according to an embodiment of the present disclosure; and

FIG. 10 is a schematic diagram of a hardware structure of a computer device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure are clearly and completely described below with reference to the drawings in the embodiments of the present disclosure. Obviously, the described embodiments are some but not all of the embodiments of the present disclosure. All other embodiments obtained by those of ordinary skill in the art based on the embodiments of the present disclosure without creative efforts shall fall within the scope of protection of the present disclosure.

It may be understood that before using the technical solutions disclosed in the embodiments of the present disclosure, users shall be informed of the type, range of use, use scenarios, etc., of personal information involved in the present disclosure and obtain the authorization of the users in an appropriate manner in accordance with relevant laws and regulations.

For example, in response to reception of an active request from a user, prompt information is sent to the user to clearly inform the user that the requested operation will require access to and use of personal information of the user. In this way, the user may independently choose, based on the prompt information, whether to provide the personal information to software or hardware, such as a computer device, an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. In addition, the pop-up window may also include a selection control for the user to choose whether to "agree" or "disagree" to provide the personal information to the computer device.

It may be understood that the above process of notifying and acquiring user authorization is only illustrative and does not constitute a limitation on the implementations of the present disclosure. Other modes that satisfy the relevant laws and regulations may also be applied in the implementations of the present disclosure.

It may be understood that the data involved in the technical solution (including but not limited to the data itself, acquisition or use of the data) shall comply with requirements of corresponding laws, regulations, and related provisions.

Short videos are an important genre for content release, such as an important genre in a content e-commerce ecosystem. High-quality short videos are currently viewed by creators to obtain video inspiration and improve shooting skills. However, although a current content e-commerce platform may provide a list of popular e-commerce short videos, it is difficult for the creators to summarize and disassemble the short videos well, resulting in inspiration sticking points in short video creation and lack of learning of video shooting skills. Although video creators may view popular videos with a large amount of data traffic, it is difficult for them to conduct a good disassembly analysis on video content, which makes it difficult for the creators to learn good shooting skills from the popular videos, affecting the quality of their video creation.

To guide the creators to create high-quality videos, the following methods are generally used: (1) manually writing shooting skills of high-quality videos for the creators to learn from; (2) designing element dimensions of high-quality videos and identifying whether a corresponding dimension is satisfied for each popular video on the list; and (3) identifying high-quality dimensions through ASR (speech-to-text) of videos. However, manual writing cannot cover specific cases, and different creators learn different types of videos, so personalized learning cannot be achieved; the high-quality dimensions of the popular videos are diverse and difficult to enumerate, and with continuous updates of online hotspots, it is difficult to perform high-quality disassembly at the video granularity; and it is difficult to interpret high-quality short videos without explanatory copywriting (such as clothing display of clothing categories) through ASR information.

In view of this, the present disclosure provides a video analysis method, an apparatus, a computer device, a storage medium, and a program product to solve the problem that it is difficult to conduct a disassembly analysis on a high-quality video.

Based on this, the technical solution of the present disclosure provides automatic analysis of a target video in a plurality of feature dimensions, improves the interpretation range and interpretation effect of the target video, and displays target analysis results corresponding to each of the feature dimensions, so as to provide video creation inspiration for a creator and facilitate the learning of video shooting skills.

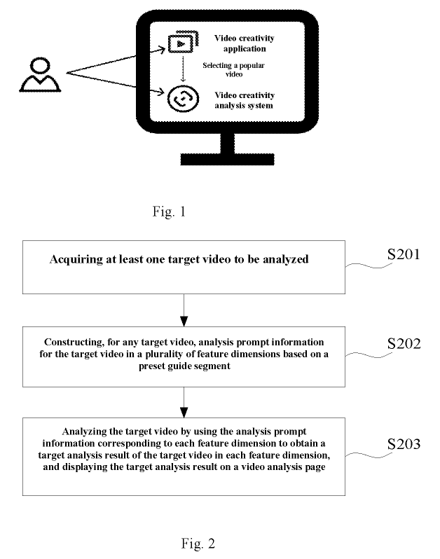

As an optional application scenario of the embodiments of the present disclosure, as shown in FIG. 1, a video creativity application and a video creativity analysis system are deployed in a computer device such as a mobile terminal or a computer, where the video creativity application may display a list of popular videos, so that a user may acquire a popular video of interest; and the video creativity analysis system analyzes a video image and/or a video copywriting of the popular video through a video processing model to generate video analysis results such as copywriting analysis, image analysis, key information analysis at the start of playback, and video content summarization, and displays the video analysis results on a video analysis page provided by the video creativity analysis system, so as to facilitate viewing of the video analysis results by a video creator, to obtain video creation inspiration from the video analysis results and guide the video creator to learn video shooting skills.

According to the embodiments of the present disclosure, an embodiment of a video analysis method is provided. It should be noted that the steps shown in the flowchart of the drawings may be performed in a computer system such as a set of computer-executable instructions, and although a logical order is shown in the flowchart, in some cases, the steps shown or described may be performed in an order different from that herein.

In this embodiment, a video analysis method is provided, which may be used for a computer device, such as a tablet, a mobile phone, a computer, etc. FIG. 2 is a flowchart of the video analysis method according to an embodiment of the present disclosure. As shown in FIG. 2, the process includes the following steps.

Step S201: acquiring at least one target video to be analyzed.

The target video is a popular video that receives a large amount of data traffic in an application, for example, a video with a TOP N click volume, a video with a TOP N viewing volume, and the like. The target video carries information such as a video image and a copy, and the information such as a video image and a copywriting of good quality may enable the target video to attract more data traffic. The target video to be analyzed is a video that requires analysis of a video image and a copywriting (such as voice-over content, art of speaking, and key information at the beginning).

Specifically, the target video may be a popular video of various categories collected from videos posted by a social application, such as a product introduction video, a beauty video, a toy video, a clothing video, and the like; may also be acquired by using a search engine to search for keywords; and may also be selected from high-quality videos downloaded locally. Certainly, the target video may also be acquired in other ways, which is not specifically limited here and may be determined by those skilled in the art based on actual needs.

Step S202: constructing, for any target video, analysis prompt information for the target video in a plurality of feature dimensions based on a preset guide segment.

The preset guide segment is information composed of preset guide words for each dimension, for example, the guide information in a video image dimension may be: "You are an expert in video image extraction. Please perform image analysis on the input target video and output a video image"; and the guide information in a video copywriting dimension may be: "You are an expert in video copywriting extraction. Please identify copywriting content in the target video and output the copywriting content carried in the target video", and so on. The feature dimension is an analysis dimension of the target video, such as a video image, a video copy, and the like; the analysis prompt information is used to guide the generation of a specific output matched with each feature dimension, and the analysis prompt information includes keywords required for video analysis, so as to clarify the analysis intention of the target video.

Specifically, for different feature dimensions, there are corresponding guide segment templates, that is, there is a one-to-one correspondence between the feature dimension and the guide segment template. For each feature dimension, the corresponding analysis prompt information is constructed by using the guide segment corresponding to the feature dimension and the video image (or the video voice-over copy, or the video image and the video voice-over copy).

Step S203: analyzing the target video by using the analysis prompt information corresponding to each feature dimension to obtain a target analysis result of the target video in each feature dimension, and displaying the target analysis result on a video analysis page.

For any feature dimension, the analysis process of the target video is guided by using the analysis prompt information corresponding to the feature dimension, so as to extract video data in a corresponding feature dimension from the target video, to obtain a corresponding target analysis result, such as a video image analysis result, a video summary result, a video voice-over analysis result, and the like.

The video analysis page is an interactive page provided by a video analysis tool. After the analysis of the target video is completed, the target analysis results in each of the feature dimensions are displayed on the video analysis page, so that the user may obtain more video creation inspiration by viewing the target analysis results in the video analysis page.

According to the video analysis method provided in this embodiment, the analysis prompt information for the target video in each feature dimension is constructed by using the preset guide segment, so that the target video may be analyzed in a corresponding feature dimension according to each piece of analysis prompt information, to obtain the target analysis result of the target video in each feature dimension. In this way, disassembly analysis is performed on the target video from a plurality of feature dimensions, and the interpretation range and interpretation effect of the target video are improved. In addition, the analyzed target analysis result is displayed on the video analysis page, which is convenient for a creator to obtain video creation inspiration from the target analysis result and learn shooting skills of the target video, thereby optimizing a learning space of the creator and facilitating improvement of the video creation quality of the creator.

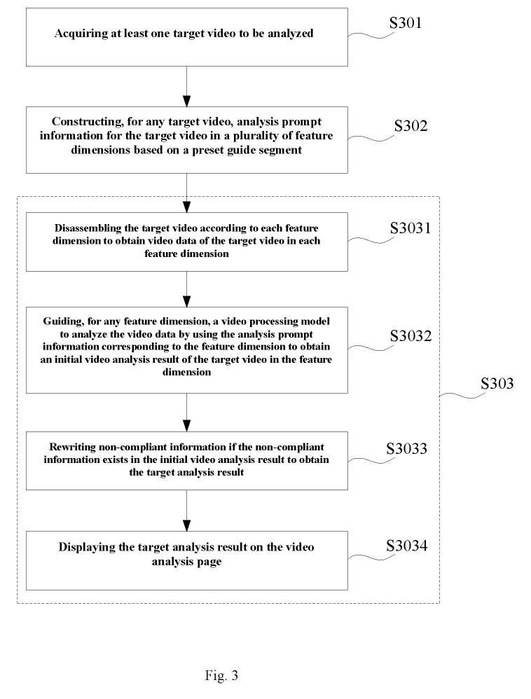

In this embodiment, a video analysis method is provided, which may be used for a computer device, such as a tablet, a mobile phone, a computer, etc. FIG. 3 is a flowchart of the video analysis method according to an embodiment of the present disclosure. As shown in FIG. 3, the process includes the following steps.

Step S301: acquiring at least one target video to be analyzed. For details, reference may be made to the relevant description of the corresponding step in the embodiment shown above, and details are not repeated here.

Step S302: constructing, for any target video, analysis prompt information for the target video in a plurality of feature dimensions based on a preset guide segment. For details, reference may be made to the relevant description of the corresponding step in the embodiment shown above, and details are not repeated here.

Step S303: analyzing the target video by using the analysis prompt information corresponding to each feature dimension to obtain a target analysis result of the target video in each feature dimension, and displaying the target analysis result on a video analysis page.

Specifically, step S303 includes the following steps.

Step S3031: disassembling the target video according to each feature dimension to obtain video data of the target video in each feature dimension.

Different feature dimensions have different decomposition modes. For different feature dimensions, the target video is disassembled according to the decomposition modes corresponding to the different feature dimensions, to obtain video data in corresponding feature dimensions. For example, in the video image dimension, the target video may be decomposed into continuous video frames according to a corresponding image decomposition mode, and video image data in each video frame is collected.

Step S3032: guiding, for any feature dimension, a video processing model to analyze the video data by using the analysis prompt information corresponding to the feature dimension to obtain an initial video analysis result of the target video in the feature dimension.

The video processing model is a pre-trained model used for video processing. Specifically, the video processing model may be a cascade model of processing models for each feature dimension, where the processing model in each feature dimension may be obtained by training a model architecture based on a large language model, may be obtained by training a model architecture based on a neural network, and may also be obtained by training a model architecture based on machine learning. The processing model is not specifically limited here, as long as the corresponding video processing function may be implemented.

The initial video analysis result is a video analysis result generated by preliminary analysis of the target video. Since the initial video analysis result may contain non-compliant information such as noise and sensitive words, it is necessary to further perform post-processing on the initial video analysis result, to obtain a compliant target analysis result.

As described above, each feature dimension corresponds to the corresponding analysis prompt information. Therefore, for any feature dimension, the video processing model may be guided by using the analysis prompt information corresponding to the feature dimension to analyze the video data in the feature dimension, so that the video processing model may output the initial video analysis result in the corresponding feature dimension.

In some optional implementations, the feature dimension includes a video copywriting dimension, the analysis prompt information corresponding to the video copywriting dimension includes copywriting analysis prompt information, the video processing model includes a copywriting processing model accordingly, and the initial video analysis result includes a copywriting analysis result.

Specifically, step S3032 may include the following steps.

Step a1: guiding the copywriting processing model to generate a video shooting structure corresponding to the target video by using the copywriting analysis prompt information.

Step a2: fine-tuning the copywriting processing model by using the video shooting structure based on a first preset fine-tuning mode to generate a fine-tuned copywriting processing model.

Step a3: analyzing the video data in the video copywriting dimension by using the fine-tuned copywriting processing model to generate the copywriting analysis result.

The copywriting analysis prompt information is prompt information for copywriting analysis of the target video; the video shooting structure represents shooting information embodied in the target video, such as voice-over art of speaking copywriting in relevant content such as prominent product advantages, detail display, and scenes in the target video; and the copywriting processing model is a pre-trained model for copywriting analysis, which may be obtained by training a model architecture based on a large language model.

Specifically, in a scenario where a voice-over copywriting of the target video is provided for the video creator to learn, the voice-over copywriting of the target video usually presents complex and diverse characteristics, and it is relatively difficult for the video creator to extract a shooting structure thereof. Therefore, the copywriting processing model with a copywriting extraction function may be trained in advance.

The copywriting analysis prompt information is constructed by using the preset guide segment and applying prompt engineering (PE) in combination with few-shot, and is used to optimize and adjust the output of the copywriting processing model, aiming at enabling the copywriting processing model to accurately output a reasonable video shooting structure, and the output will be used as a basis for subsequent model fine-tuning.

The first preset fine-tuning mode is a preset model fine-tuning mode, such as a two-stage fine-tuning mode, a distillation-based SFT fine-tuning mode, and the like, which may be selected here according to actual needs and is not specifically limited. The copywriting processing model is fine-tuned by using the video shooting structure according to the first preset fine-tuning mode, so as to obtain the copywriting processing model capable of outputting a high-quality video copy.

Taking the distillation-based SFT fine-tuning mode as an example, by distilling a larger-scale model, a smaller-scale model with a smaller number of parameters is expected to achieve a similar high-quality effect as the larger-scale model in terms of output results, while significantly reducing the inference cost of the model. Specifically, first, a batch of automatic speech recognition (ASR) data of real target videos are selected, and a larger-scale model is guided by using the copywriting analysis prompt information to generate a corresponding video shooting structure; then, based on the video shooting structure analyzed by the larger-scale model, an SFT fine-tuning operation is performed on a smaller-scale copywriting processing model by using the video shooting structure, to obtain the fine-tuned copywriting processing model.

Then, the fine-tuned copywriting processing model is used to identify a video voice-over copywriting for the video data of the target video in the video copywriting dimension, to generate the copywriting analysis result corresponding to the target video.

In the above implementation, the corresponding video shooting structure is extracted from the target video by the copywriting processing model according to the copywriting analysis prompt information, so as to generate the structured copywriting analysis result according to the video shooting structure, thereby realizing effective interpretation of video copywriting information and helping the video creator learn the voice-over copywriting in the target video.

In some optional implementations, the feature dimension includes a video image dimension, the analysis prompt information corresponding to the video image dimension includes image analysis prompt information, the video processing model includes an image processing model accordingly, and the initial video analysis result includes an image analysis result.

Specifically, step S3032 may include the following steps.

Step b1: guiding the image processing model to perform multi-dimensional image analysis on the video data in the video image dimension by using the image analysis prompt information to obtain image analysis data in a plurality of analysis dimensions.

Step b2: processing the image analysis data based on the image processing model to generate an image analysis result in at least one analysis dimension.

The image analysis prompt information is prompt information for sound and image analysis of the target video; the multi-dimensional image analysis is multi-dimensional analysis of the sound and image, such as a person, a scene, a product use experience, a detail display, and the like that appear in the target video, and a specific required dimension may be determined according to actual needs; and the image processing model is a pre-trained model for video sound and image analysis, which may be obtained by training a model architecture based on a large language model.

The image analysis prompt information is constructed by using the preset guide segment and applying prompt engineering (PE) in combination with few-shot for image analysis of different dimensions, so that the saturation of key information in the image analysis result output by the image processing model is as high as possible.

The image processing model is guided by using the image analysis prompt information to analyze an image of the video data analyzed in the video image dimension from a plurality of dimensions, to obtain the image analysis data in each dimension. Then, the image analysis data in each analysis dimension is described by text by using the image processing model, to generate the corresponding image analysis result.

It should be noted that if there is no highlight information in a certain dimension when performing multi-dimensional analysis on the video sound and image, information in this dimension will not be output, so as to ensure the effectiveness and conciseness of the output image analysis information.

In the above implementation, when processing the image content of the target video, the image processing model may be used to analyze the video sound and image of the target video to obtain a structured image text summary, which provides great help for the video creator to learn the content of the target video, and helps the video creator understand and master the information in the target video more efficiently, and promotes the learning and creation process.

In some optional implementations, acquiring the video data corresponding to the video image dimension includes the following steps.

Step c1: acquiring a source file corresponding to the target video according to a download address of the target video.

Step c2: analyzing the video data in the video image dimension in the source file.

A download address of the target video is acquired by using a remote procedure call (RPC) service, and a source file of the target video may be downloaded from the download address. During the download process, in consideration of various factors such as performance of the computer device, video memory and efficiency, frame extraction resolution and frame rate of the target video may be adjusted and set, and the corresponding source file is downloaded according to the adjusted frame extraction resolution and frame rate. The image processing model is guided by using the image analysis prompt information to analyze the source file of the target video to obtain the video data of the target video in the video image dimension, thereby identifying content in the video data and generating a corresponding image analysis result.

In the above implementation, the corresponding source file is acquired by using the frame extraction method according to the download address of the target video, thereby ensuring accuracy of subsequent target video interpretation.

In some optional implementations, after the image analysis result in at least one analysis dimension is generated, the method further includes: deleting the source file corresponding to the target video.

After the analysis of the video image is completed, in order to maintain the storage space of the computer device, the source file of the target video is deleted to avoid waste of storage resources.

In some optional implementations, the feature dimension includes a start key information dimension, the analysis prompt information corresponding to the start key information dimension includes key information analysis prompt information, the video processing model includes an information extraction model accordingly, and the initial video analysis result includes a key information analysis result.

Specifically, step S3032 may include the following steps.

Step d1: guiding the information extraction model to generate video key information of the target video within a preset start duration by using the key information analysis prompt information.

Step d2: fine-tuning the information extraction model by using the video key information based on a second preset fine-tuning mode to generate a fine-tuned information extraction model.

Step d3: analyzing the video data in the start key information dimension by using the fine-tuned information extraction model to generate the key information analysis result.

The key analysis prompt information is prompt information for analyzing the key information at the beginning of the target video; the preset start duration is a preset start playback duration of the target video, such as within 3 seconds after the start of playback, within 5 seconds after the start of playback, and the like; the video key information represents information of interest that may attract traffic and is embodied in the target video; and the information extraction model is a pre-trained model for key information extraction, which may be obtained by training a model architecture based on a large language model.

The key analysis prompt information is constructed by using the preset guide segment and applying prompt engineering (PE), and is used to optimize and adjust the output of the key information extraction model, aiming at enabling the key information extraction model to extract the video key information at the beginning of the target video, and the output will be used as a basis for subsequent model fine-tuning.

The second preset fine-tuning mode is a preset model fine-tuning mode, such as a two-stage fine-tuning mode, a distillation-based SFT fine-tuning mode, and the like, which may be selected here according to actual needs and is not specifically limited. The key information extraction model is fine-tuned by using the video key information according to the second preset fine-tuning mode, so as to obtain the key information extraction model capable of outputting high-quality video key information.

Taking the distillation-based SFT fine-tuning mode as an example, by distilling a larger-scale model, a smaller-scale model with a smaller number of parameters is expected to achieve a similar high-quality effect as the larger-scale model in terms of output results, while significantly reducing the inference cost of the model. Specifically, first, a batch of automatic speech recognition (ASR) data of real target videos are selected, and a larger-scale model is guided by using the key information analysis prompt information to generate the corresponding video key information; then, based on the video key information analyzed by the larger-scale model, an SFT fine-tuning operation is performed on a smaller-scale key information extraction model by using the video key information, to obtain the fine-tuned key information extraction model.

Then, content identification is performed on the video data of the target video in the start key information dimension by using the fine-tuned key information extraction model, to generate the key information analysis result corresponding to the target video.

In the process of video creation and dissemination, an attractive voice-over copywriting at the beginning of a video plays a crucial role in attracting a viewer to stay. In the above implementation, a corresponding key information extraction model is trained to determine whether the beginning of the target video has the video key information, and the extracted key information analysis result is displayed on the video analysis page, so as to improve the creation and learning ability of the video creator, help the video creator better grasp key elements of a video opening, enhance key information identification of the target video, optimize the interpretation and learning space of the target video, and improve the attractiveness and dissemination effect of the created video.

In some optional implementations, the feature dimension includes a content summary dimension, the analysis prompt information corresponding to the content summary dimension includes summary analysis prompt information, the video processing model includes an information summary model accordingly, and the initial video analysis result includes a content summary analysis result.

Specifically, step S3032 may include: guiding the information summary model to perform content summarization on the video data in the content summary dimension by using the summary analysis prompt information to generate the content summary analysis result.

The summary analysis prompt information is prompt information for summarizing highlight content in the target video. The information summary model is a pre-trained model for summarizing highlight content, which may be obtained by training a model architecture based on a large language model.

The summary analysis prompt information is constructed by using the preset guide segment and applying prompt engineering (PE), to guide the information summary model to generate a concise and specific content summary, so that the final content summary analysis result may be as short as possible on the premise of ensuring core information, thereby helping the video creator quickly grasp key highlights in the target video.

In terms of summarization of highlight content, a detailed summary result may help the video creator learn more comprehensively, but also brings difficulties for the video creator to select different types of videos. In the above implementation, a corresponding information summary model is trained in advance to generate summary content, for example, generate a concise content summary result within 25 words, so as to highlight the highlight content in the target video, facilitate selection of a learning direction for the video creator, and improve learning efficiency.

In some optional implementations, the method further includes the following steps.

Step e1: generating an evaluation result corresponding to the content summary analysis result in response to an evaluation operation for the content summary analysis result.

Step e2: adjusting a model parameter of the information summary model if the evaluation result represents that the content summary analysis result does not satisfy a summary condition.

The content summary analysis result output by the information summary model is evaluated in one or more dimensions such as a grammatical structure (such as a verb-object structure), detection of an applied copywriting analysis result, creativity, and the number of words, to generate a corresponding evaluation result. The grammatical structure is used to evaluate whether the content summary analysis result has a clear grammatical structure; the detection of the applied copywriting analysis result is used to evaluate whether the content summary analysis result is summarized more specifically according to the copywriting analysis result, instead of applying the copywriting analysis; the creativity is used to evaluate whether the content summary analysis result has the creativity to attract the public to watch; and the number of words is used to evaluate whether the number of words in the content summary analysis result is within a preset number of words (such as 25 words).

A technician may evaluate the content summary analysis result output by the information summary model, and determine whether the information summary model needs further improvement based on the evaluation result. If the evaluation result represents that the content summary analysis result does not satisfy the summary condition, the content summary analysis result that satisfies the summary condition may be used as training data, and the model parameter of the information summary model may be adjusted to improve the content summarization analysis effect of the information summary model.

Step S3033: rewriting non-compliant information if the non-compliant information exists in the initial video analysis result to obtain the target analysis result.

A compliance check is performed on the initial video analysis result to determine whether there is non- compliant information such as a violation word and a sensitive word. If there is non-compliant information, another word with the same semantics as the non-compliant information is retrieved from a thesaurus, and the non-compliant information is rewritten with the another word to obtain a rewritten video analysis result. In order to ensure the compliance of the finally generated target analysis result, semantic review is performed on the rewritten video analysis result, to eliminate the non-compliant information existing in the video analysis result at the semantic level, and finally obtain the compliant target analysis result.

Step S3034: displaying the target analysis result on the video analysis page. For details, reference may be made to the relevant description of the corresponding step in the embodiment shown above, and details are not repeated here.

According to the video analysis method provided in this embodiment, the target video is disassembled according to each of the feature dimensions, and the video processing model is guided by using the analysis prompt information of the corresponding feature dimension to analyze the video data, to obtain the corresponding video analysis result. In this way, analysis of the target video in the plurality of feature dimensions is realized, the limitation of ASR text information is broken through, and the interpretation range and interpretation effect of the target video are improved. The non-compliant information in the video analysis result is processed to obtain the corresponding target analysis result, thereby ensuring the compliance of the target analysis result.

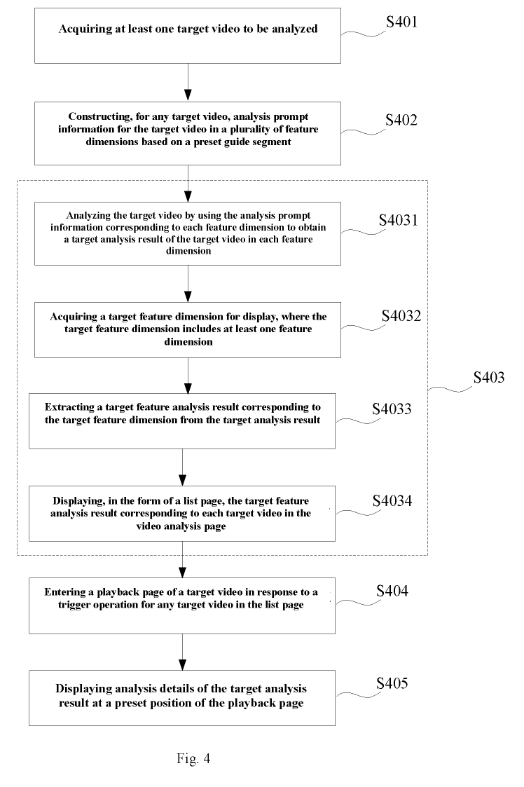

In this embodiment, a video analysis method is provided, which may be used for a computer device, such as a tablet, a mobile phone, a computer, etc. FIG. 4 is a flowchart of the video analysis method according to an embodiment of the present disclosure. As shown in FIG. 4, the process includes the following steps.

Step S401: acquiring at least one target video to be analyzed. For details, reference may be made to the relevant description of the corresponding step in the embodiment shown above, and details are not repeated here.

Step S402: constructing, for any target video, analysis prompt information for the target video in a plurality of feature dimensions based on a preset guide segment. For details, reference may be made to the relevant description of the corresponding step in the embodiment shown above, and details are not repeated here.

Step S403: analyzing the target video by using the analysis prompt information corresponding to each feature dimension to obtain a target analysis result of the target video in each feature dimension, and displaying the target analysis result on a video analysis page.

Specifically, step S403 includes the following steps.

Step S4031: analyzing the target video by using the analysis prompt information corresponding to each feature dimension to obtain the target analysis result of the target video in each feature dimension. For details, reference may be made to the relevant description of the corresponding step in the embodiment shown above, and details are not repeated here.

Step S4032: acquiring a target feature dimension for display, where the target feature dimension includes at least one feature dimension.

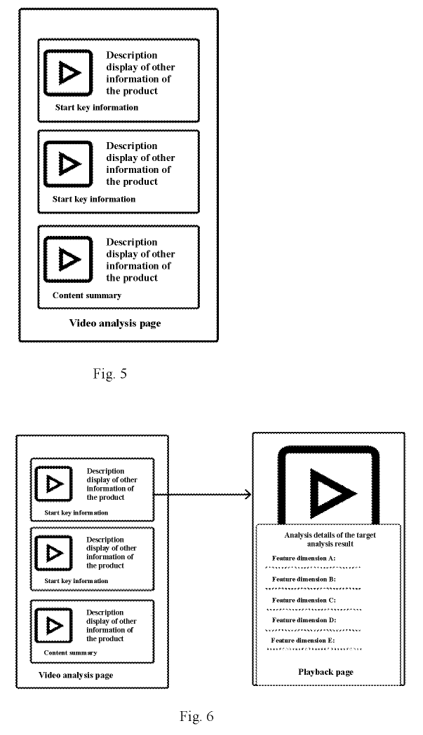

The target feature dimension is used to reflect video highlights and video key content of the target video, and is one or more feature dimensions displayed on a homepage of the video analysis page with the target video. Specifically, the display of the target feature dimension has a corresponding display priority, which is preset, for example, the priority of the start key information dimension is higher than the priority of the content summary dimension. When the two dimensions coexist, the analysis result corresponding to the start key information dimension is preferentially displayed, and when there is no start key information dimension, the analysis result corresponding to the content summary dimension is preferentially displayed, as shown in FIG. 5.

Step S4033: extracting a target feature analysis result corresponding to the target feature dimension from the target analysis result.

Different feature dimensions correspond to different feature analysis results. According to the feature dimension included in the target feature dimension, the feature analysis result generated in the corresponding feature dimension is extracted from the target analysis result, and the extracted feature analysis result is determined as the target feature analysis result corresponding to the target feature dimension.

Step S4034: displaying, in the form of a list page, the target feature analysis result corresponding to each target video in the video analysis page.

Each target video and the target feature analysis result corresponding thereto are encapsulated into a card, to avoid a gap between the target video and the target feature analysis result thereof. Then, each of the cards is displayed in the video analysis page in the form of a list page.

In some optional implementations, the method further includes the following step.

Step S404: entering a playback page of a target video in response to a trigger operation for any target video in the list page.

The user may click on any target video in the list page, and accordingly, the video analysis page may switch from the video analysis page to the playback page of the target video triggered by the user in response to the trigger operation of the user for the any target video, and the target video is played on the playback page.

Step S405: displaying analysis details of the target analysis result at a preset position of the playback page.

The analysis details are detailed descriptions for the target analysis result; the preset position is a preset position for displaying the analysis details, for example, displaying under the playback page, superimposing on the playback page for displaying, and the like. As shown in FIG. 6, after entering the playback page of the target video, the target video is played above the playback page, and the analysis details of the target analysis result are displayed under the playback page.

According to the video analysis method provided in this embodiment, the target feature analysis result corresponding to the target feature dimension is extracted from the target analysis result, and the target feature analysis result corresponding to each target video is displayed in the video analysis page in the form of a list page, so that a video creator may intuitively understand the video content of each target video, and it is convenient for the video creator to select a video type of interest, to implement personalized learning. In addition, the trigger operation for any target video in the list page is supported, to enter the playback page of the target video, and the analysis details of the target analysis result are displayed on the playback page, so that the video creator may intuitively understand the video analysis results of each target video in a plurality of feature dimensions, and it is convenient for the video creator to obtain video creation inspiration therefrom and learn shooting skills of high-quality target videos.

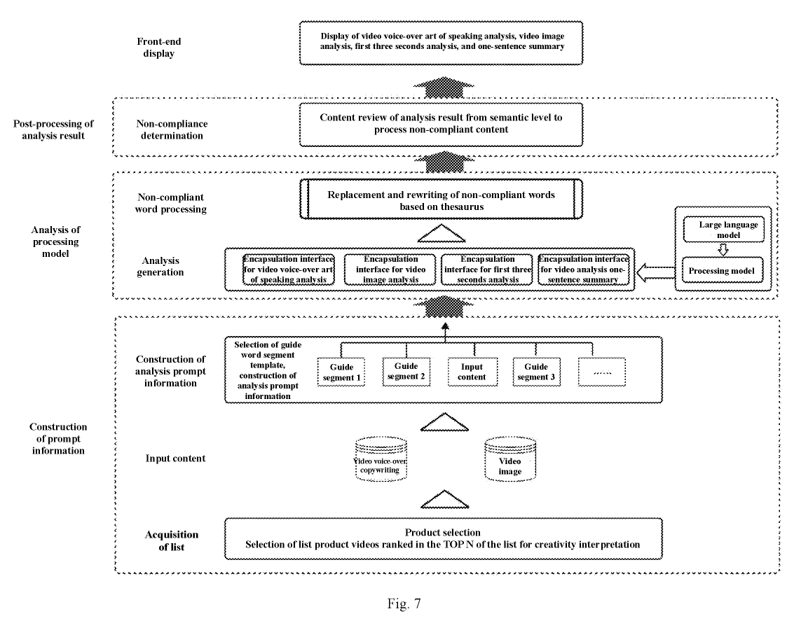

As a specific application embodiment of the embodiments of the present disclosure, the above video analysis method is described in combination with an e-commerce application scenario. As shown in FIG. 7, through a list of popular videos provided by an e-commerce platform, list product videos ranked in the TOP N of the list are selected for creativity interpretation, the list product videos are preliminarily analyzed, a video image and/or a video voice-over copywriting included therein are extracted, and analysis prompt information corresponding to video voice-over art of speaking analysis, video image analysis, first three seconds (that is, 3 seconds after the start of a video) analysis, and video analysis one-sentence summary (that is, content summary) is constructed by using a preset guide word segment.

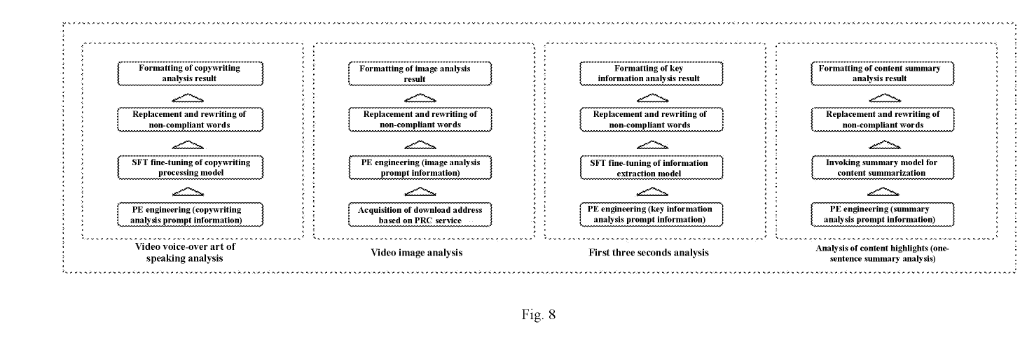

The video voice-over art of speaking analysis, the video image analysis, the first three seconds analysis, and the video analysis one-sentence summary respectively correspond to corresponding encapsulation interfaces, and each encapsulation interface is connected to a corresponding processing model (the processing model is obtained by training based on a model architecture of a large language model). A corresponding processing model is guided by the analysis prompt information corresponding to each analysis dimension to generate a video voice-over art of speaking analysis result, a video image analysis result, a first three seconds analysis result, and a video analysis one-sentence summary result, as shown in FIG. 8.

Then, e-commerce special words in the video voice-over art of speaking analysis result, the video image analysis result, the first three seconds analysis result, and the video analysis one-sentence summary result are checked, the detected e-commerce special words are replaced and rewritten by using a thesaurus, and the analysis results after the replacement and rewriting are formatted, as shown in FIG. 8.

Further, semantic detection is performed on the formatted video voice-over art of speaking analysis result, the formatted video image analysis result, the formatted first three seconds analysis result, and the formatted video analysis one-sentence summary result, and semantic content that touches on sensitive e-commerce expressions or non-compliant expressions of the e-commerce platform is modified and adjusted to generate a video voice-over art of speaking analysis result, a video image analysis result, a first three seconds analysis result, and a video analysis one-sentence summary result that satisfy e-commerce compliance, and each of the analysis results are displayed on a front-end video analysis page, so as to display the interpretation of the list product videos to the user, thereby guiding the user to learn product video shooting skills and providing the user with creation inspiration for product videos.

In this embodiment, a video analysis apparatus is further provided. The apparatus is used to implement the above embodiments and preferred implementations, which have been described and will not be repeated here. As used below, the term "module" may implement a combination of software and/or hardware for a predetermined function. Although the apparatus described in the following embodiments is preferably implemented in software, implementation in hardware, or a combination of software and hardware is also possible and contemplated.

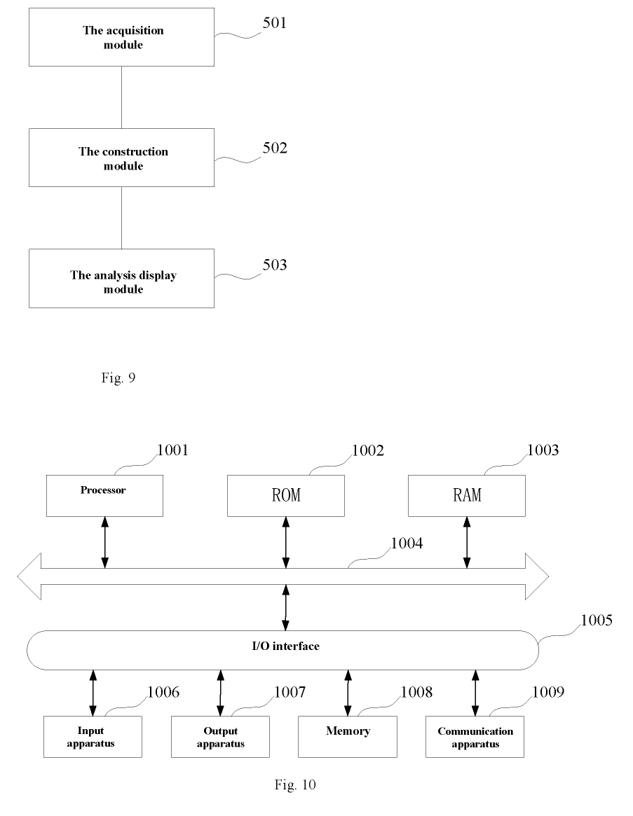

This embodiment provides a video analysis apparatus, as shown in FIG. 9, including:

an acquisition module 501, configured to acquire at least one target video to be analyzed;

The construction module 502 is configured to construct, for any target video, analysis prompt information for the target video in a plurality of feature dimensions based on a preset guide segment.

The analysis display module 503 is configured to analyze the target video by using the analysis prompt information corresponding to each feature dimension to obtain a target analysis result of the target video in each feature dimension, and display the target analysis result on a video analysis page.

In some optional implementations, the analysis display module 503 includes:

a disassembly unit, configured to disassemble the target video according to each feature dimension to obtain video data of the target video in each feature dimension;

an analysis unit, configured to guide, for any feature dimension, a video processing model to analyze the video data by using the analysis prompt information corresponding to the feature dimension to obtain an initial video analysis result of the target video in the feature dimension; and

a non-compliance processing unit, configured to rewrite non-compliant information if the non-compliant information exists in the initial video analysis result to obtain the target analysis result.

In some optional implementations, the feature dimension includes a video copywriting dimension, the analysis prompt information corresponding to the video copywriting dimension includes copywriting analysis prompt information, the video processing model includes a copywriting processing model accordingly, and the initial video analysis result includes a copywriting analysis result. Specifically, the analysis unit includes:

a first guidance subunit, configured to guide the copywriting processing model to generate a video shooting structure corresponding to the target video by using the copywriting analysis prompt information;

a first model fine-tuning subunit, configured to fine-tune the copywriting processing model by using the video shooting structure based on a first preset fine-tuning mode to generate a fine-tuned copywriting processing model; and

a copywriting analysis subunit, configured to analyze the video data in the video copywriting dimension by using the fine-tuned copywriting processing model to generate the copywriting analysis result.

In some optional implementations, the feature dimension includes a video image dimension, the analysis prompt information corresponding to the video image dimension includes image analysis prompt information, the video processing model includes an image processing model accordingly, and the initial video analysis result includes an image analysis result. Specifically, the analysis unit includes:

a second guidance subunit, configured to guide the image processing model to perform multi-dimensional image analysis on the video data in the video image dimension by using the image analysis prompt information to obtain image analysis data in a plurality of analysis dimensions; and

an image analysis subunit, configured to process the image analysis data based on the image processing model to generate an image analysis result in at least one analysis dimension.

In some optional implementations, the analysis display module 503 further includes:

a source file acquisition unit, configured to acquire a source file corresponding to the target video according to a download address of the target video; and

a source file analysis unit, configured to analyze the video data in the video image dimension in the source file.

In some optional implementations, the analysis display module 503 further includes:

a source file deletion unit, configured to delete the source file corresponding to the target video.

In some optional implementations, the feature dimension includes a start key information dimension, the analysis prompt information corresponding to the video copywriting dimension includes key information analysis prompt information, the video processing model includes an information extraction model accordingly, and the initial video analysis result includes a key information analysis result. Specifically, the analysis unit includes:

a third guidance subunit, configured to guide the information extraction model to generate video key information of the target video within a preset start duration by using the key information analysis prompt information;

a second model fine-tuning subunit, configured to fine-tune the information extraction model by using the video key information based on a second preset fine-tuning mode to generate a fine-tuned information extraction model; and

a key information analysis subunit, configured to analyze the video data in the start key information dimension by using the fine-tuned information extraction model to generate the key information analysis result.

In some optional implementations, the feature dimension includes a content summary dimension, the analysis prompt information corresponding to the content summary dimension includes summary analysis prompt information, the video processing model includes an information summary model accordingly, and the initial video analysis result includes a content summary analysis result. Specifically, the analysis unit further includes:

a content summary analysis subunit, configured to guide the information summary model to perform content summarization on the video data in the content summary dimension by using the summary analysis prompt information to generate the content summary analysis result.

In some optional implementations, the analysis unit further includes:

an evaluation subunit, configured to generate an evaluation result corresponding to the content summary analysis result in response to an evaluation operation for the content summary analysis result; and

a model parameter adjustment subunit, configured to adjust a model parameter of the information summary model if the evaluation result represents that the content summary analysis result does not satisfy a summary condition.

In some optional implementations, the analysis display module 503 further includes:

a display dimension acquisition unit, configured to acquire a target feature dimension for display, where the target feature dimension includes at least one feature dimension;

an analysis result extraction unit, configured to extract a target feature analysis result corresponding to the target feature dimension from the target analysis result; and

a list display unit, configured to display, in the form of a list page, the target feature analysis result corresponding to each target video in the video analysis page.

In some optional implementations, the apparatus further includes:

a video playback module, configured to enter a playback page of a target video in response to a trigger operation for any target video in the list page; and

a detail display module, configured to display analysis details of the target analysis result at a preset position of the playback page.

Further functional descriptions of the above modules and units are the same as those in the corresponding embodiments above, and details are not repeated here.

The video analysis apparatus provided by the embodiments of the present disclosure may perform the video analysis method provided by any embodiment of the present disclosure, and has the corresponding functional modules for performing the method and beneficial effects. The analysis prompt information for the target video in each feature dimension is constructed by using the preset guide segment, so that the target video may be analyzed in a corresponding feature dimension according to each piece of analysis prompt information, to obtain the target analysis result of the target video in each feature dimension. In this way, disassembly analysis is performed on the target video from a plurality of feature dimensions, and the interpretation range and interpretation effect of the target video are improved. In addition, the analyzed target analysis result is displayed on the video analysis page, which is convenient for a creator to obtain video creation inspiration from the target analysis result and learn shooting skills of the target video, thereby optimizing a learning space of the creator and facilitating improvement of the video creation quality of the creator.

FIG. 10 is a schematic diagram of a structure of a computer device provided by an embodiment of the present disclosure.

Reference is made specifically to FIG. 10 below, which is a schematic diagram of a structure of a computer device suitable for implementing the embodiments of the present disclosure. The computer device may include a processor (such as a central processing unit, a graphics processor, etc.) 1001, which may perform various appropriate actions and processing according to a program stored in a read-only memory (ROM) 1002 or a program loaded from a memory 1008 into a random access memory (RAM) 1003. The RAM 1003 further stores various programs and data required for operations of the computer device. The processor 1001, the ROM 1002, and the RAM 1003 are connected to each other through a bus 1004. An input/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, a gyroscope, etc.; an output apparatus 1007 including, for example, a liquid crystal display (LCD), a speaker, a vibrator, etc.; the memory 1008 including, for example, a magnetic tape, a hard disk, etc.; and a communication apparatus 1009. The communication apparatus 1009 may allow the computer device to perform wireless or wired communication with other devices to exchange data. Although FIG. 10 shows a computer device having various apparatuses, it should be understood that it is not required to implement or have all the apparatuses shown, and more or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 1009, or installed from the memory 1008, or installed from the ROM 1002. When the computer program is executed by the processor 1001, the preceding functions limited in the video analysis method of the embodiments of the present disclosure are executed.

The computer device shown in FIG. 10 is merely an example, and should not impose any limitation on the functions and the range of use of the embodiments of the present disclosure.

The embodiments of the present disclosure further provide a computer-readable storage medium. The preceding method according to the embodiments of the present disclosure may be implemented in hardware and firmware, or implemented as computer code that may be recorded on a storage medium or originally stored in a remote storage medium or a non-transitory machine-readable storage medium and downloaded through a network and to be stored in a local storage medium, so that the method described herein may be stored in such software on a storage medium using a general-purpose computer, a dedicated processor, or programmable or dedicated hardware. The storage medium may be a magnetic disk, an optical disc, a read-only memory, a random access memory, a flash memory, a hard disk, or a solid-state disk, and further, the storage medium may include a combination of the preceding types of memories. It may be understood that the computer, the processor, the microprocessor controller, or the programmable hardware includes a storage component that may store or receive software or computer code, and when the software or the computer code is accessed and executed by the computer, the processor, or the hardware, the video analysis method shown in the preceding embodiments is implemented.

A part of the present disclosure may be applied as a computer program product, for example, computer program instructions that, when executed by a computer, may invoke or provide the method and/or the technical solution according to the present disclosure through operations of the computer. Those skilled in the art should understand that the computer program instructions exist in a computer-readable medium in forms including, but not limited to, a source file, an executable file, an installation package file, and the like, and accordingly, the computer program instructions are executed by the computer in manners including, but not limited to, the computer directly executing the instructions, or the computer compiling the instructions and then executing a corresponding compiled program, or the computer reading and executing the instructions, or the computer reading and installing the instructions and then executing a corresponding installed program. Herein, the computer-readable medium may be any available computer-readable storage medium or communication medium accessible by the computer.

Although the embodiments of the present disclosure are described in conjunction with the drawings, those skilled in the art may make various modifications and variations without departing from the spirit and scope of the present disclosure, and such modifications and variations fall within the scope defined by the appended claims.

1. A video analysis method, comprising:
acquiring at least one target video to be analyzed;
constructing, for any of the target video, analysis prompt information for the target video in a plurality of feature dimensions based on a preset guide segment; and
analyzing the target video by using the analysis prompt information corresponding to each of the feature dimensions to obtain a target analysis result of the target video in each of the feature dimensions, and displaying the target analysis result on a video analysis page.

2. The method of claim 1, wherein the analyzing the target video by using the analysis prompt information corresponding to each of the feature dimensions to obtain the target analysis result of the target video in each of the feature dimensions comprises:
analyzing the target video according to each of the feature dimensions to obtain video data of the target video in each of the feature dimensions;
guiding, for any of the feature dimension, a video processing model to analyze the video data by using the analysis prompt information corresponding to the feature dimension to obtain an initial video analysis result of the target video in the feature dimension; and
rewriting non-compliant information if the non-compliant information exists in the initial video analysis result to obtain the target analysis result.

3. The method of claim 2, wherein the feature dimensions comprise a video copywriting dimension, and the analysis prompt information corresponding to the video copywriting dimension comprises copywriting analysis prompt information; and
the guiding a video processing model to analyze the video data by using the analysis prompt information corresponding to the feature dimension to obtain an initial video analysis result of the target video in the feature dimension comprises:
guiding a copywriting processing model to generate a video shooting structure corresponding to the target video by using the copywriting analysis prompt information;
fine-tuning the copywriting processing model by using the video shooting structure based on a first preset fine-tuning mode to generate a fine-tuned copywriting processing model; and
analyzing the video data in the video copywriting dimension by using the fine-tuned copywriting processing model to generate a copywriting analysis result,
wherein the video processing model comprises the copywriting processing model, and the initial video analysis result comprises the copywriting analysis result.

4. The method of claim 2, wherein the feature dimensions comprise a video image dimension, and the analysis prompt information corresponding to the video image dimension comprises image analysis prompt information; and
the guiding a video processing model to analyze the video data by using the analysis prompt information corresponding to the feature dimension to obtain an initial video analysis result of the target video in the feature dimension comprises:
guiding an image processing model to perform multi-dimensional image analysis on the video data in the video image dimension by using the image analysis prompt information to obtain image analysis data in a plurality of analysis dimensions; and
processing the image analysis data based on the image processing model to generate an image analysis result in at least one of the analysis dimension,
wherein the video processing model comprises the image processing model, and the initial video analysis result comprises the image analysis result.

5. The method of claim 4, wherein the acquiring the video data corresponding to the video image dimension comprises:
acquiring a source file corresponding to the target video according to a download address of the target video; and
analyzing the video data in the video image dimension in the source file.

6. The method of claim 5, wherein after the image analysis result in at least one of the analysis dimension is generated, the method further comprises:
deleting the source file corresponding to the target video.

7. The method of claim 2, wherein the feature dimensions comprise a start key information dimension, and the analysis prompt information corresponding to the start key information dimension comprises key information analysis prompt information; and
the guiding a video processing model to analyze the video data by using the analysis prompt information corresponding to the feature dimension to obtain an initial video analysis result of the target video in the feature dimension comprises:
guiding an information extraction model to generate video key information of the target video within a preset start duration by using the key information analysis prompt information;
fine-tuning the information extraction model by using the video key information based on a second preset fine-tuning mode to generate a fine-tuned information extraction model; and
analyzing the video data in the start key information dimension by using the fine-tuned information extraction model to generate a key information analysis result,
wherein the video processing model comprises the information extraction model, and the initial video analysis result comprises the key information analysis result.

8. The method of claim 2, wherein the feature dimensions comprise a content summary dimension, and the analysis prompt information corresponding to the content summary dimension comprises summary analysis prompt information; and
the guiding a video processing model to analyze the video data by using the analysis prompt information corresponding to the feature dimension to obtain an initial video analysis result of the target video in the feature dimension comprises:
guiding an information summary model to perform content summarization on the video data in the content summary dimension by using the summary analysis prompt information to generate a content summary analysis result,
wherein the video processing model comprises the information summary model, and the initial video analysis result comprises the content summary analysis result.

9. The method of claim 8, further comprising:
generating an evaluation result corresponding to the content summary analysis result in response to an evaluation operation for the content summary analysis result; and
adjusting a model parameter of the information summary model if the evaluation result represents that the content summary analysis result does not satisfy a summary condition.

10. The method of claim 1, wherein the displaying the target analysis result on a video analysis page comprises:
acquiring a target feature dimension for display, wherein the target feature dimension comprises at least one of the feature dimension;
extracting a target feature analysis result corresponding to the target feature dimension from the target analysis result; and
displaying, in the form of a list page, the target feature analysis result corresponding to each of the target video in the video analysis page.

11. The method of claim 10, further comprising:
entering a playback page of a target video in response to a trigger operation for any target video in the list page; and
displaying analysis details of the target analysis result at a preset position of the playback page.

12. A computer device, comprising:
a memory and a processor, wherein the memory and the processor are communicatively connected to each other, the memory stores computer instructions, and the processor executes the computer instructions to perform a video analysis method comprising:
acquiring at least one target video to be analyzed;
constructing, for any of the target video, analysis prompt information for the target video in a plurality of feature dimensions based on a preset guide segment; and
analyzing the target video by using the analysis prompt information corresponding to each of the feature dimensions to obtain a target analysis result of the target video in each of the feature dimensions, and displaying the target analysis result on a video analysis page.

13. The computer device of claim 12, wherein the analyzing the target video by using the analysis prompt information corresponding to each of the feature dimensions to obtain the target analysis result of the target video in each of the feature dimensions comprises:
analyzing the target video according to each of the feature dimensions to obtain video data of the target video in each of the feature dimensions;
guiding, for any of the feature dimension, a video processing model to analyze the video data by using the analysis prompt information corresponding to the feature dimension to obtain an initial video analysis result of the target video in the feature dimension; and
rewriting non-compliant information if the non-compliant information exists in the initial video analysis result to obtain the target analysis result.

14. The computer device of claim 13, wherein the feature dimensions comprise a video copywriting dimension, and the analysis prompt information corresponding to the video copywriting dimension comprises copywriting analysis prompt information; and
the guiding a video processing model to analyze the video data by using the analysis prompt information corresponding to the feature dimension to obtain an initial video analysis result of the target video in the feature dimension comprises:
guiding a copywriting processing model to generate a video shooting structure corresponding to the target video by using the copywriting analysis prompt information;
fine-tuning the copywriting processing model by using the video shooting structure based on a first preset fine-tuning mode to generate a fine-tuned copywriting processing model; and
analyzing the video data in the video copywriting dimension by using the fine-tuned copywriting processing model to generate a copywriting analysis result,
wherein the video processing model comprises the copywriting processing model, and the initial video analysis result comprises the copywriting analysis result.

15. The computer device of claim 13, wherein the feature dimensions comprise a video image dimension, and the analysis prompt information corresponding to the video image dimension comprises image analysis prompt information; and
the guiding a video processing model to analyze the video data by using the analysis prompt information corresponding to the feature dimension to obtain an initial video analysis result of the target video in the feature dimension comprises:
guiding an image processing model to perform multi-dimensional image analysis on the video data in the video image dimension by using the image analysis prompt information to obtain image analysis data in a plurality of analysis dimensions; and
processing the image analysis data based on the image processing model to generate an image analysis result in at least one of the analysis dimension,
wherein the video processing model comprises the image processing model, and the initial video analysis result comprises the image analysis result.

16. The computer device of claim 15, wherein the acquiring the video data corresponding to the video image dimension comprises:
acquiring a source file corresponding to the target video according to a download address of the target video; and
analyzing the video data in the video image dimension in the source file.

17. A non-transitory computer-readable storage medium storing computer instructions, wherein the computer instructions are used to cause a computer to perform a video analysis method comprising:
acquiring at least one target video to be analyzed;
constructing, for any of the target video, analysis prompt information for the target video in a plurality of feature dimensions based on a preset guide segment; and
analyzing the target video by using the analysis prompt information corresponding to each of the feature dimensions to obtain a target analysis result of the target video in each of the feature dimensions, and displaying the target analysis result on a video analysis page.

18. The non-transitory computer-readable storage medium of claim 17, wherein the analyzing the target video by using the analysis prompt information corresponding to each of the feature dimensions to obtain the target analysis result of the target video in each of the feature dimensions comprises:
analyzing the target video according to each of the feature dimensions to obtain video data of the target video in each of the feature dimensions;
guiding, for any of the feature dimension, a video processing model to analyze the video data by using the analysis prompt information corresponding to the feature dimension to obtain an initial video analysis result of the target video in the feature dimension; and
rewriting non-compliant information if the non-compliant information exists in the initial video analysis result to obtain the target analysis result.

19. The non-transitory computer-readable storage medium of claim 18, wherein the feature dimensions comprise a video copywriting dimension, and the analysis prompt information corresponding to the video copywriting dimension comprises copywriting analysis prompt information; and
the guiding a video processing model to analyze the video data by using the analysis prompt information corresponding to the feature dimension to obtain an initial video analysis result of the target video in the feature dimension comprises:
guiding a copywriting processing model to generate a video shooting structure corresponding to the target video by using the copywriting analysis prompt information;
fine-tuning the copywriting processing model by using the video shooting structure based on a first preset fine-tuning mode to generate a fine-tuned copywriting processing model; and
analyzing the video data in the video copywriting dimension by using the fine-tuned copywriting processing model to generate a copywriting analysis result,
wherein the video processing model comprises the copywriting processing model, and the initial video analysis result comprises the copywriting analysis result.

20. The non-transitory computer-readable storage medium of claim 18, wherein the feature dimensions comprise a video image dimension, and the analysis prompt information corresponding to the video image dimension comprises image analysis prompt information; and
the guiding a video processing model to analyze the video data by using the analysis prompt information corresponding to the feature dimension to obtain an initial video analysis result of the target video in the feature dimension comprises:
guiding an image processing model to perform multi-dimensional image analysis on the video data in the video image dimension by using the image analysis prompt information to obtain image analysis data in a plurality of analysis dimensions; and
processing the image analysis data based on the image processing model to generate an image analysis result in at least one of the analysis dimension,
wherein the video processing model comprises the image processing model, and the initial video analysis result comprises the image analysis result.
